(19) United States
(12) Patent Application Publication
(10) Pub. No.: US 2025/0044912 A1
(43) Pub. Date: Feb. 6, 2025

(54) OBJECT BASED CONTENT RECOMMENDATION

(71) Applicant: Snap Inc., Santa Monica, CA (US)

(72) Inventors: Shubham Chawla, Santa Clara, CA (US); Hyojung Chun, Long Island City, NY (US); Anvi Dalal, New York, NY (US); Yunchu He, Lawrence Township, NJ (US); Hao Hu, Bellevue, WA (US); Sarah Lensing, Brooklyn, NY (US); Yanjia Li, Torrance, CA (US); Ana Medinac, Queens, NY (US); Bindi Patel, Cohoes, GA (US); Patrick Poirson, Gilbert, AZ (US); Chiung-Fu Shih, Foster City, CA (US); Jeremy Staub, Brooklyn, NY (US); Kevin Dechau Tang, New York, NY (US); Ryan Tran, San Diego, CA (US); Andrew Wan, Marina del Rey, CA (US); Cindy Wang, Great Neck, NY (US); Alireza Zareian, Huntington Beach, CA (US)

(21) Appl. No.: 18/790,543

(22) Filed: Jul. 31, 2024

Related U.S. Application Data
(60) Provisional application No. 63/517,728, filed on Aug. 4, 2023.

(51) Int. Cl. G06F 3/04817; G06V 10/764

(52) U.S. Cl. CPC G06F 3/04817; G06V 10/764

(57) ABSTRACT

Systems and methods for object-based content recommendation are described. A camera feed comprising a plurality of image frames is caused to be displayed at a client device. An object is detected within an image frame from the camera feed, the object corresponding with an object category. Responsive to detecting the object, an icon associated with the object category is selected and displayed at a position upon the camera feed. The icon corresponds with a media collection related to the object category. An input is received selecting the icon. Responsive to the input, a presentation of media items from the media collection is displayed at the client device. By detecting real-world objects and surfacing relevant virtual icons that link to associated media, an augmented reality experience is provided allowing virtual content to be overlaid and anchored to objects in reality.

### CROSS-REFERENCE TO RELATED APPLICATION

This patent application claims the benefit of U.S. Provisional Patent Application No. 63/517,728, filed Aug. 4, 2023, entitled “OBJECT BASED CONTENT RECOMMENDATION”, which is incorporated by reference herein in its entirety.

### BACKGROUND

Mobile devices like smartphones and tablets are increasingly equipped with advanced cameras and sensors, enabling new augmented reality (AR) applications utilizing computer vision. One area of development has focused on real-time object recognition from the mobile camera perspective. By analyzing the live camera feed using machine learning models, objects and features of interest can be identified.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings in which:

FIG. 1 is a diagrammatic representation of a networked environment in which the present disclosure may be deployed, in accordance with some examples.

FIG. 2 is a diagrammatic representation of a messaging system, in accordance with some examples, that has both client-side and server-side functionality.

FIG. 3 is a flowchart depicting a method for providing object-based content recommendations, in accordance with one embodiment.

FIG. 4 is an interface flow diagram depicting a series of interfaces presented at a client device, in accordance with one embodiment.

FIG. 5 is a diagrammatic representation of a machine in the form of a computer system within which a set of instructions may be executed for causing the machine to perform any one or more of the methodologies discussed herein, in accordance with some examples.

FIG. 6 is a block diagram showing a software architecture within which examples may be implemented.

FIG. 7 is a diagrammatic representation of a processing environment, in accordance with some examples.

### DETAILED DESCRIPTION

The present disclosure relates to systems and methods for real-time object recognition, and content suggestion on mobile devices. In particular, the techniques involve using on-device machine learning models to recognize objects depicted among one or more image frames presented at a client device and prompting users with relevant content based on the identified objects. For example, upon detecting a dog within a camera feed, the system may identify a media collection associated with “pets,” wherein the media collection corresponds with a icon to be displayed at a position within the camera feed at the client device. A user may then select the icon in order to display and access the media collection.

According to certain example embodiments, a system performs operations that include: causing display of a camera feed at a client device, wherein the camera feed may be generated by a camera associated with the client device, and analyzing one or more image frames of the camera feed based on a machine learned model trained to detect predefined objects. The system may then select and display one or more icons based on the recognized objects, wherein the one or more icons each correspond with media collections associated with object categories of the detected objects. Selection of an icon from among the one or more icons causes the system to display a presentation of a media collection associated with the selected icon.

In some embodiments, one or more object detection techniques may be used, including machine learned models trained on image datasets to recognize objects and classify them into categories. For example, deep neural networks such as convolutional neural networks (CNNs) may be trained on image datasets to develop object detectors. Other machine learned models such as support vector machines, decision trees, k-nearest neighbors and boosted classifiers may additionally or alternatively be used. The models are trained with sample images of different objects labeled with their categories. At runtime, object detection may be performed on every frame from the camera feed, at certain predefined intervals, or based on a request received from the client device.

In some embodiments, the machine learned model runs entirely on-device without external transmission of data prior to a user selecting a prompt. Compared to traditional approaches that offload processing to remote servers, some embodiments of the techniques disclosed herein allow for real-time object recognition and low latency prompting by leveraging efficient on-device machine learning. For example, the on-device model may include a neural network trained to identify objects of interest, wherein the model runs locally on the client device, analyzing each frame from a camera feed generated at the client device. Minimal data is transmitted external to the device prior to the user selecting an icon. Compared to traditional approaches that offload processing to remote servers, the present techniques allow for real-time object recognition and low latency prompting by leveraging efficient on-device machine learning. This provides an engaging augmented reality experience while enhancing privacy through localized processing.

In some embodiments, responsive to detecting one or more objects among the plurality of image frames of the camera feed, the system may perform operations that include selecting an icon associated with an object category of the object. A database or other data store links object categories to various icons, wherein attributes of the icons may correspond with a given object category. When an object is detected, the corresponding icon is programmatically selected from the data store. Icons may be simple images, animations, 3D models or other visual representations. Different icons may be associated with a given object category. Rules may govern which specific icon is selected for a given category. For example, icon selection may be based on factors that includes attributes of detected objects, as well as various contextual conditions of the client device, including location, time, and user profile data.

In some embodiments, the system causes display of the selected icon at a position upon the camera feed at the client device. The icon may be overlaid on the live camera feed at or near the location of the detected object, or at a predefined position within a menu element, or among a set of icons. For example, if a tree is detected in the top right corner of the frame, the corresponding icon may be positioned at the top right corner, anchored to the tree. Occlusion handling may be implemented so icons appear occluded if their anchor point is behind another object. Icon display positions may be determined based on object display positions.

In some embodiments, the causing display of the icon at the position upon the camera feed includes: presenting an ephemeral display of an identifier associated with the object category proximate to the icon for a period of time. For example, when a new icon appears, it may briefly display an identifier associated with the object or object category at a position within the camera feed, such as proximate to the detected object, or within a menu element among a set of icons (e.g. “Dog” or “Tree”). This helps the user understand what real-world object has triggered the icon. The text may fade out after a few seconds.

A user may provide an input that selects the icon, for example by tapping on the icon, or providing an input that includes an input attribute such as an input pressure or duration. Inputs are processed using standard touchscreen and gesture recognition techniques. Different actions may be triggered depending on the specific input, for example a tap vs a long press on the icon.

In some embodiments, the system causes display of a presentation of one or more media items from a media collection associated with the selected icon at the client device responsive to the input that selects the icon. The media items may include images, videos, animations, 3D models, filters, virtual environments, or other effects and media. The content is retrieved from a data store associated with the icon. The presentation may take over a portion or the entirety of the screen. The user can then swipe through and select filters to apply to themselves.

In some embodiments, the presentation of the one or more media items comprises a media carousel or gallery to display one or more graphical elements that represent each of the one or more media items. As described above, a carousel or gallery user interface (UI) may be used to present scrollable media options. Each item may correspond with a graphical icon or thumbnail. Swiping may transition between media items.

In some embodiments, the detecting the object includes: receiving a request to perform object recognition at the client device; and detecting the object within the image frame from among the plurality of image frames of the camera feed responsive to the request. For example, rather than passive detection on all frames, in certain embodiments object recognition may be explicitly triggered by a user request. For example, there may be a button to actively scan for objects. This may save battery life by only running detection when needed.

In some embodiments, multiple objects may be detected and their corresponding icons displayed simultaneously. For example, if both a dog and a tree are detected, the respective dog and tree icons would both appear at positions within the camera feed of the client device.

### Networked Computing Environment

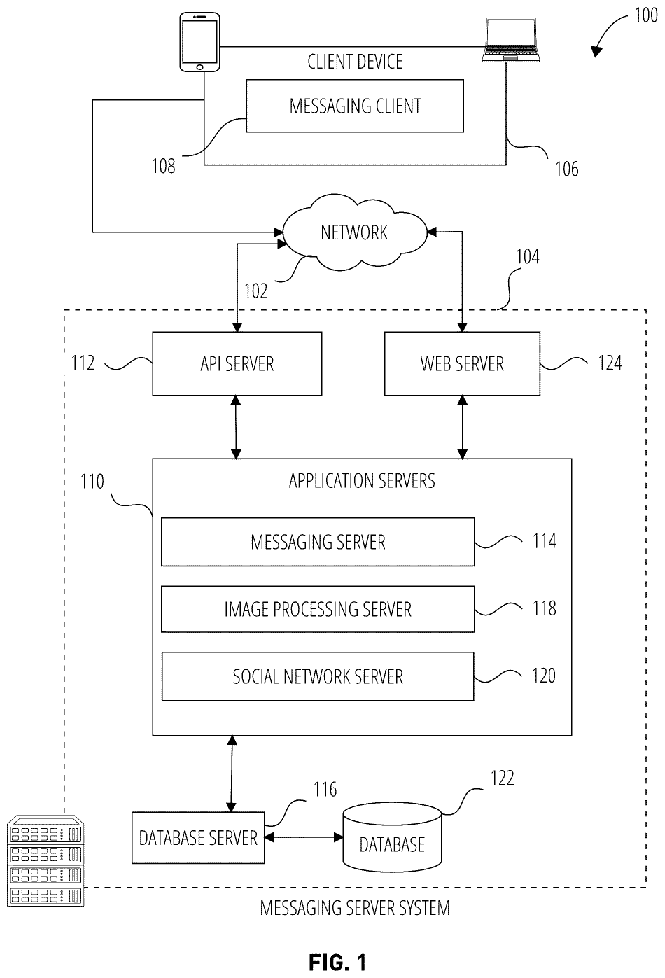

FIG. 1 is a block diagram showing an example messaging system 100 for exchanging data (e.g., messages and associated content) over a network. The messaging system 100 includes multiple instances of a client device 106, each of which hosts a number of applications, including a messaging client 108. Each messaging client 108 is communicatively coupled to other instances of the messaging client 108 and a messaging server system 104 via a network 102 (e.g., the internet).

A messaging client 108 is able to communicate and exchange data with another messaging client 108 and with the messaging server system 104 via the network 102. The data exchanged between messaging client 108, and between a messaging client 108 and the messaging server system 104, includes functions (e.g., commands to invoke functions) as well as payload data (e.g., text, audio, video or other multimedia data).

The messaging server system 104 provides server-side functionality via the network 102 to a particular messaging client 108. While certain functions of the messaging system 100 are described herein as being performed by either a messaging client 108 or by the messaging server system 104, the location of certain functionality either within the messaging client 108 or the messaging server system 104 may be a design choice. For example, it may be technically preferable to initially deploy certain technology and functionality within the messaging server system 104 but to later migrate this technology and functionality to the messaging client 108 where a client device 106 has sufficient processing capacity.

The messaging server system 104 supports various services and operations that are provided to the messaging client 108. Such operations include transmitting data to, receiving data from, and processing data generated by the messaging client 108. This data may include message content, client device information, geolocation information, media augmentation and overlays, message content persistence conditions, social network information, and live event information, as examples. Data exchanges within the messaging system 100 are invoked and controlled through functions available via user interfaces (UIs) of the messaging client 108.

Turning now specifically to the messaging server system 104, an Application Program Interface (API) server 112 is coupled to, and provides a programmatic interface to, application servers 110. The application servers 110 are communicatively coupled to a database server 116, which facilitates access to a database 122 that stores data associated with messages processed by the application servers 110. Similarly, a web server 124 is coupled to the application servers 110, and provides web-based interfaces to the application servers 110. To this end, the web server 124 processes incoming network requests over the Hypertext Transfer Protocol (HTTP) and several other related protocols. In certain embodiments, the database 122 may include a decentralized database.

The Application Program Interface (API) server 112 receives and transmits message data (e.g., commands and message payloads) between the client device 106 and the application servers 110. Specifically, the Application Program Interface (API) server 112 provides a set of interfaces (e.g., routines and protocols) that can be called or queried by the messaging client 108 in order to invoke functionality of the application servers 110. The Application Program Interface (API) server 112 exposes various functions supported by the application servers 110, including account registration, login functionality, the sending of messages, via the application servers 110, from a particular messaging client 108 to another messaging client 108, the sending of media files (e.g., images or video) from a messaging client 108 to a messaging server 114, and for possible access by another messaging client 108, the settings of a collection of media data (e.g., story), the retrieval of a list of friends of a user of a client device 106, the retrieval of such collections, the retrieval of messages and content, the addition and deletion of entities (e.g., friends) to an entity graph (e.g., a social graph), the location of friends within a social graph, and opening an application event (e.g., relating to the messaging client 108).

The application servers 110 host a number of server applications and subsystems, including for example a messaging server 114, an image processing server 118, and a social network server 120. The messaging server 114 implements a number of message processing technologies and functions, particularly related to the aggregation and other processing of content (e.g., textual and multimedia content) included in messages received from multiple instances of the messaging client 108. As will be described in further detail, the text and media content from multiple sources may be aggregated into collections of content (e.g., called stories or galleries). These collections are then made available to the messaging client 108. Other processor and memory intensive processing of data may also be performed server-side by the messaging server 114, in view of the hardware requirements for such processing.

The application servers 110 also include an image processing server 118 that is dedicated to performing various image processing operations, typically with respect to images or video within the payload of a message sent from or received at the messaging server 114.

The social network server 120 supports various social networking functions and services and makes these functions and services available to the messaging server 114. Examples of functions and services supported by the social network server 120 include the identification of other users of the messaging system 100 with which a particular user has relationships or is “following,” and also the identification of other entities and interests of a particular user.

### System Architecture

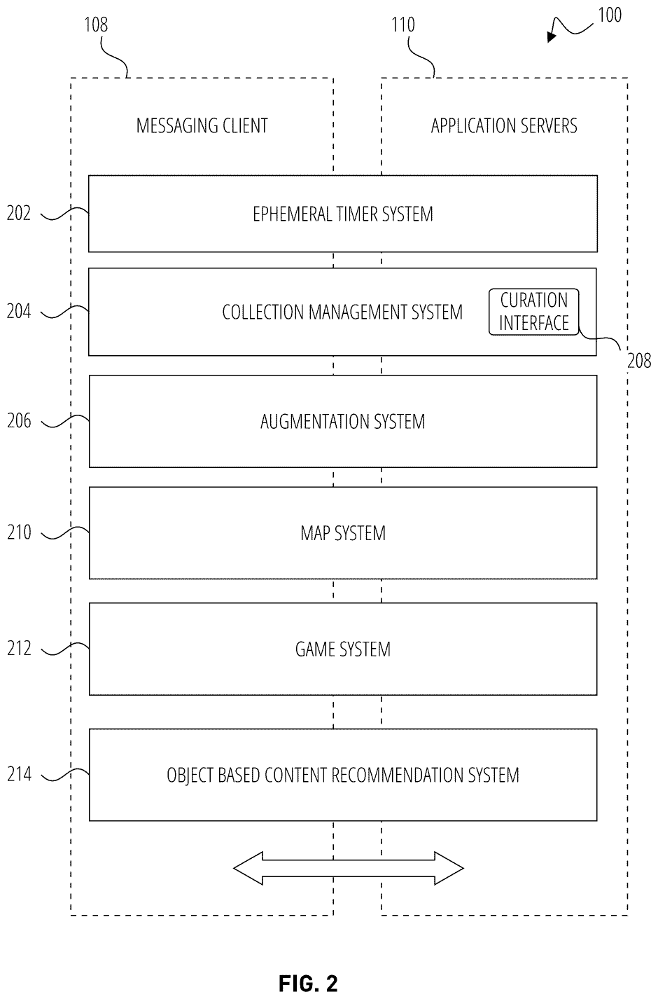

FIG. 2 is a block diagram illustrating further details regarding the messaging system 100, according to some examples. Specifically, the messaging system 100 is shown to comprise the messaging client 108 and the application servers 110. The messaging system 100 embodies a number of subsystems, which are supported on the client-side by the messaging client 108 and on the sever-side by the application servers 110. These subsystems include, for example, an ephemeral timer system 202, a collection management system 204, an augmentation system 206, a map system 210, a game system 212, and an Object Based Content Recommendation System 214.

The ephemeral timer system 202 is responsible for enforcing the temporary or time-limited access to content by the messaging client 108 and the messaging server 114. The ephemeral timer system 202 incorporates a number of timers that, based on duration and display parameters associated with a message, or collection of messages (e.g., a story), selectively enable access (e.g., for presentation and display) to messages and associated content via the messaging client 108. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the messaging client 108.

The collection management system 204 furthermore includes a curation interface 208 that allows a collection manager to manage and curate a particular collection of content. For example, the curation interface 208 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 206 provides various functions that enable a user to augment (e.g., annotate or otherwise modify or edit) media content associated with a message. For example, the augmentation system 206 provides functions related to the generation and publishing of media overlays for messages processed by the messaging system 100. The augmentation system 206 operatively supplies a media overlay or augmentation (e.g., an image filter) to the messaging client 108 based on a geolocation of the client device 106. In another example, the augmentation system 206 operatively supplies a media overlay to the messaging client 108 based on other information, such as social network information of the user of the client device 106. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 106. For example, the media overlay may include text or image that can be overlaid on top of a photograph taken by the client device 106. In another example, the media overlay includes an identification of a location overlay (e.g., Venice beach), a name of a live event, or a name of a merchant overlay (e.g., Beach Coffee House). In another example, the augmentation system 206 uses the geolocation of the client device 106 to identify a media overlay that includes the name of a merchant at the geolocation of the client device 106. The media overlay may include other indicia associated with the merchant. The media overlays may be stored in the database 122 and accessed through the database server 116.

In some examples, the augmentation system 206 provides a user-based publication platform that enables users to select a geolocation on a map and upload content associated with the selected geolocation. The user may also specify circumstances under which a particular media overlay should be offered to other users. The augmentation system 206 generates a media overlay that includes the uploaded content and associates the uploaded content with the selected geolocation.

In other examples, the augmentation system 206 provides a merchant-based publication platform that enables merchants to select a particular media overlay associated with a geolocation via a bidding process. For example, the augmentation system 206 associates the media overlay of the highest bidding merchant with a corresponding geolocation for a predefined amount of time.

The map system 210 provides various geographic location functions, and supports the presentation of map-based media content and messages by the messaging client 108. For example, the map system 210 enables the display of user icons or avatars on a map to indicate a current or past location of “friends” of a user, as well as media content (e.g., collections of messages including photographs and videos) generated by such friends, within the context of a map. For example, a message posted by a user to the messaging system 100 from a specific geographic location may be displayed within the context of a map at that particular location to “friends” of a specific user on a map interface of the messaging client 108. A user can furthermore share his or her location and status information (e.g., using an appropriate status avatar) with other users of the messaging system 100 via the messaging client 108, with this location and status information being similarly displayed within the context of a map interface of the messaging client 108 to selected users.

The game system 212 provides various gaming functions within the context of the messaging client 108. The messaging client 108 provides a game interface providing a list of available games that can be launched by a user within the context of the messaging client 108, and played with other users of the messaging system 100. The messaging system 100 further enables a particular user to invite other users to participate in the play of a specific game, by issuing invitations to such other users from the messaging client 108. The messaging client 108 also supports both the voice and text messaging (e.g., chats) within the context of gameplay, provides a leaderboard for the games, and also supports the provision of in-game rewards (e.g., coins and items).

The Object Based Content Recommendation System 214 provides functions that may include: causing display of a camera feed comprising a plurality of image frames at a client device 106. The camera feed may be displayed in real-time from a camera associated with the client device 106. The display may take up the entirety of the screen or be contained in a viewfinder window. The functions may further comprise detecting an object within an image frame from among the plurality of image frames of the camera feed, wherein the object corresponding with an object category. At runtime, object detection may be performed on every frame from the camera feed, at certain predefined intervals, or based on a request received from the client device 106.

The Object Based Content Recommendation System 214 performs operations that further include selecting an icon associated with the object category responsive to the detecting the object within the image frame. The database 122 may store links object categories to various graphical icons. When an object is detected, the corresponding icon is programmatically looked up in the data store.

The Object Based Content Recommendation System 214 performs operations that further include causing display of the icon at a position upon the camera feed at the client device 106. The icon may be overlaid on the live camera feed at or near the location of the detected object. Responsive to receiving an input that selects the icon, the Object Based Content Recommendation System 214 causes display of a presentation of the one or more media items associated with the selected icon at the client device 106.

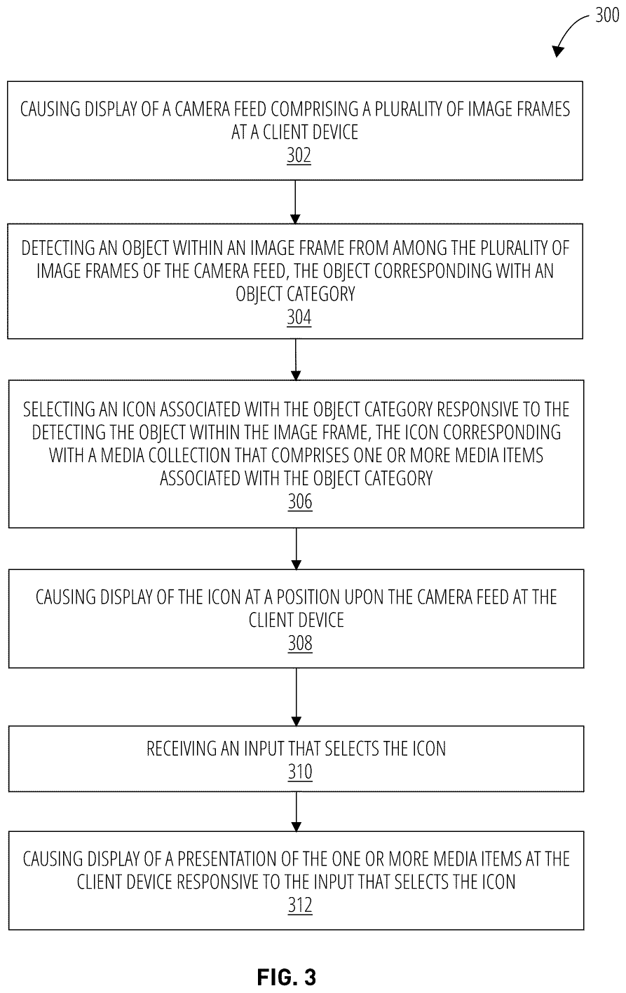

FIG. 3 is a flowchart illustrating operations of an Object Based Content Recommendation System 214 in performing a method 300 for providing object based content recommendations, in accordance with one embodiment. Operations of the method 300 may be performed by one or more subsystems of the messaging system 100 described above with respect to FIG. 2, such as the Object Based Content Recommendation System 214. As shown in FIG. 3, the method 300 includes one or more operations 302, 304, 306, 308, 310, and 312.

At operation 302, the Object Based Content Recommendation System 214 performs operations that include causing display of a camera feed comprising a plurality of image frames at a client device 106. The camera feed may be displayed in real-time from the device's camera. The display may take up the entirety of the screen or be contained in a viewfinder window. Standard techniques are used to access the camera feed using system APIs on mobile operating systems such as iOS and Android. The camera may be a rear-facing camera to detect objects in the environment, or a front-facing camera to detect the user's face.

At operation 304, the system detects an object within an image frame from among the plurality of image frames of the camera feed, wherein the object corresponding with an object category. Various object detection techniques may be used, including machine learning models trained on image datasets to recognize objects and classify them into categories. For example, deep neural networks such as convolutional neural networks (CNNs) may be trained on image datasets to develop object detectors. Other machine learning models such as support vector machines, decision trees, k-nearest neighbors and boosted classifiers may additionally or alternatively be used. The models are trained with sample images of different objects labeled with their categories. At runtime, object detection may be performed on every frame from the camera feed, at certain intervals, or based on a request received from the client device 106.

At operation 306, the system selects an icon associated with an object category of the detected object responsive to the detecting the object within the image frame. A database or other data store links object categories to graphical icons, wherein properties of the graphical icons may correspond with attributes of the detected objects. When an object is detected, the corresponding icon is programmatically looked up in the data store. Icons may be simple images, animations, 3D models or other visual representations. Different icons may be associated with a given object category. Rules may govern which specific icon is selected for a given category. For example, icon selection may be randomized or depend on user preferences.

At operation 308, the system causes display of the selected icon (or icons) at a position upon the camera feed at the client device. The icon may be overlaid on the live camera feed at or near the location of the detected object, or in some embodiments may be presented within or proximate to a menu element configured to display one or more icons. For example, if a tree is detected in the top right corner of the frame, the corresponding virtual icon may be positioned at the top right corner, anchored to the tree, or within a menu element. Occlusion handling may be implemented so icons appear occluded if their anchor point is behind another object. Icon display positions may be determined based on object display positions.

At operation 310, the system receives an input that selects the icon. User input selects icons, for example by tapping on the icon. Inputs are processed using standard touchscreen and gesture recognition techniques. Different actions may be triggered depending on the specific input, for example a tap vs a long press on the icon.

At operation 312, the system causes display of a presentation of the one or more media items associated with the selected icon at the client device 106 responsive to the input that selects the icon in operation 310. When the icon is selected, corresponding media content is displayed. This may include images, videos, animations, 3D models, filters, virtual environments, or other effects and media. The content is retrieved from a data store associated with the icon. The presentation may take over a portion or the entirety of the screen. For example, selecting a dog icon may show a carousel of pet or animal related filters and media. The user can then swipe through and select filters to apply to themselves.

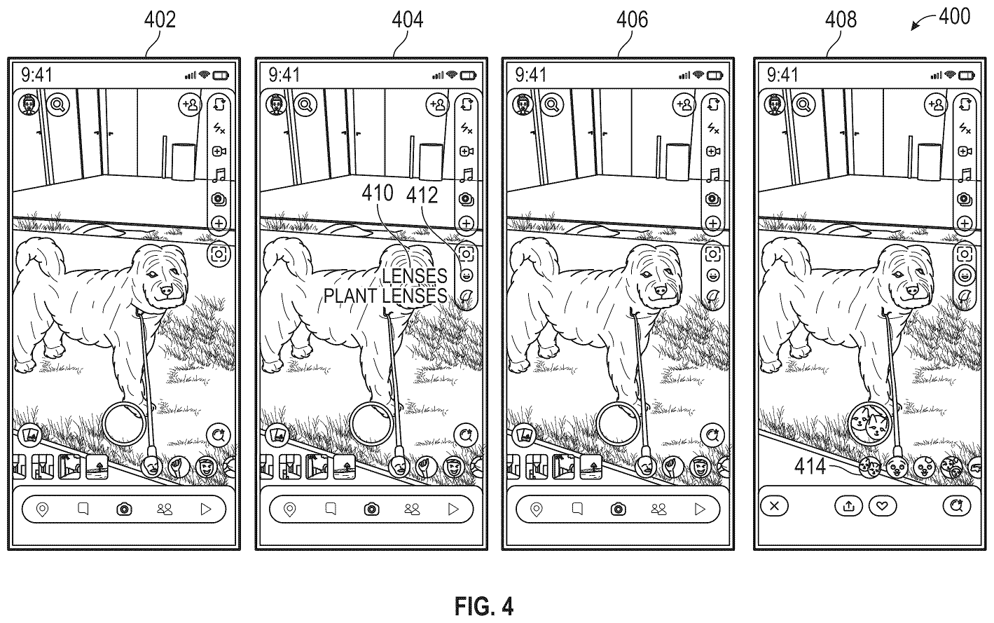

FIG. 4 is an interface flow diagram 400 depicting a series of interfaces presented by an Object Based Content Recommendation System 214, in accordance with one embodiment.

As seen in the interface flow diagram 400, interface 402 corresponds to operation 302 of the method 300, and depicts a camera feed comprising a plurality of image frames displayed at a client device 106. The camera feed takes up the full screen and is being displayed in real-time from the device's camera.

Interface 404 corresponds to operations 304, 306, and 308 of the method 300, and shows the camera feed with an object detected within an image frame, in this case a dog, and a plant. Responsive to detecting the dog and the plant, one or more icons 412 representing object categories of the detected objects are selected and displayed at a position within the camera feed at the client device. In some embodiments, the one or more icons 412 may be presented at positions proximate to the detected objects within the camera feed, or as seen in interface 404, may be presented at a position within a menu element. In some embodiments, ephemeral identifiers 410 associated with the selected icon may be presented proximate to the one or more icons 412 for a period of time before vanishing, as depicted in interface 406.

As seen in interface 408, which corresponds to operations 310 and 312 of the method 300, a user may provide an input to select an icon from among the one or more icons 412. Responsive to this input, a presentation of a media collection 414 associated with the selected icon is displayed. In this case, a carousel of different pet-related augmented reality filters is presented. The user can now swipe through the filters and select one to apply to the camera feed.

### Machine Architecture

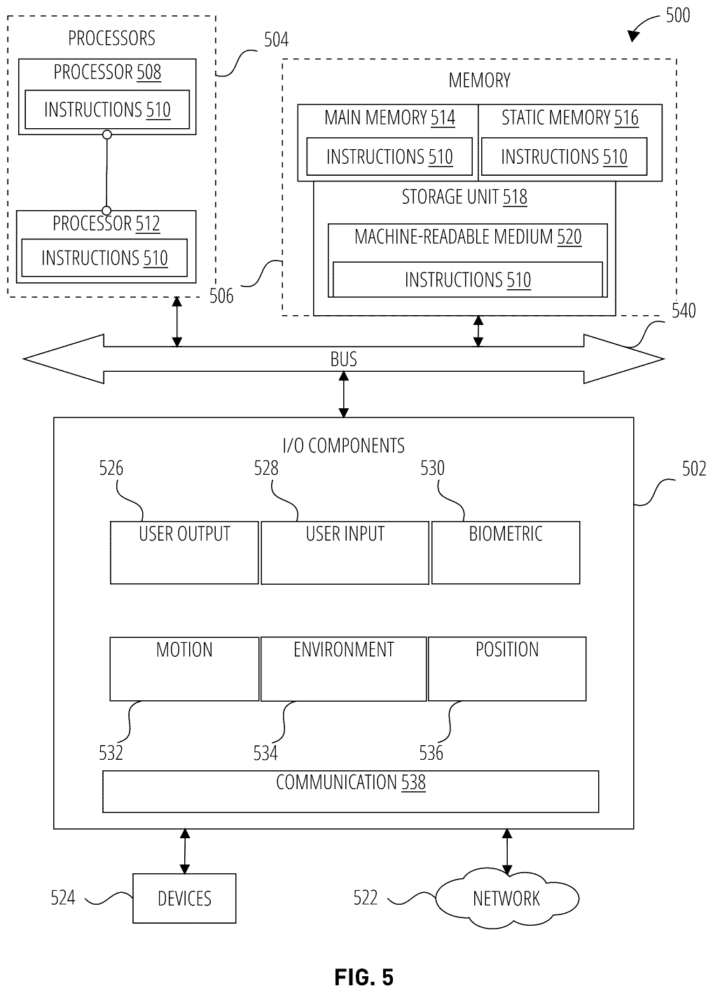

FIG. 5 is a diagrammatic representation of the machine 500 within which instructions 510 (e.g., software, a program, an application, an applet, an app, or other executable code) for causing the machine 500 to perform any one or more of the methodologies discussed herein may be executed. For example, the instructions 510 may cause the machine 500 to execute any one or more of the methods described herein. The instructions 510 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 510, sequentially or otherwise, that specify actions to be taken by the machine 500. Further, while only a single machine 500 is illustrated, the term “machine” shall also be taken to include a collection of machines that individually or jointly execute the instructions 510 to perform any one or more of the methodologies discussed herein. The machine 500, for example, may comprise the client device 106 or any one of a number of server devices forming part of the messaging server system 104. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 638, which may be configured to communicate with each other via a bus 540. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 508 and a processor 512 that execute the instructions 510. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 514, a static memory 516, and a storage unit 518, both accessible to the processors 504 via the bus 540. The main memory 506, the static memory 516, and storage unit 518 store the instructions 510 embodying any one or more of the methodologies or functions described herein. The instructions 510 may also reside, completely or partially, within the main memory 514, within the static memory 516, within machine-readable medium 520 within the storage unit 518, within at least one of the processors 504 (e.g., within the Processor's cache memory), or any suitable combination thereof, during execution thereof by the machine 500.

The I/O components 502 may include a wide variety of components to receive input, provide output, produce output, transmit information, exchange information, capture measurements, and so on. The specific I/O components 502 that are included in a particular machine will depend on the type of machine. For example, portable machines such as mobile phones may include a touch input device or other such input mechanisms, while a headless server machine will likely not include such a touch input device. It will be appreciated that the I/O components 502 may include many other components that are not shown in FIG. 5. In various examples, the I/O components 502 may include user output components 526 and user input components 528. The user output components 526 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 502 may include biometric components 530, motion components 532, environmental components 534, or position components 536, among a wide array of other components. For example, the biometric components 530 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 532 include acceleration sensor components (e.g., accelerometer), gravitation sensor components, rotation sensor components (e.g., gyroscope).

The environmental components 534 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the client device 106 may have a camera system comprising, for example, front cameras on a front surface of the client device 106 and rear cameras on a rear surface of the client device 106. The front cameras may, for example, be used to capture still images and video of a user of the client device 106 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the client device 106 may also include a 360° camera for capturing 360° photographs and videos.

Further, the camera system of a client device 106 may include dual rear cameras (e.g., a primary camera as well as a depth-sensing camera), or even triple, quad or penta rear camera configurations on the front and rear sides of the client device 106. These multiple cameras systems may include a wide camera, an ultra-wide camera, a telephoto camera, a macro camera and a depth sensor, for example.

The position components 536 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 502 further include communication components 538 operable to couple the machine 500 to a network 522 or devices 524 via respective coupling or connections. For example, the communication components 538 may include a network interface Component or another suitable device to interface with the network 522. In further examples, the communication components 538 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 524 may be another machine or any of a wide variety of peripheral devices (e.g., a peripheral device coupled via a USB).

Moreover, the communication components 538 may detect identifiers or include components operable to detect identifiers. For example, the communication components 538 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 538, such as location via Internet Protocol (IP) geolocation, location via Wi-Fi® signal triangulation, location via detecting an NFC beacon signal that may indicate a particular location, and so forth.

The various memories (e.g., main memory 514, static memory 516, and memory of the processors 504) and storage unit 518 may store one or more sets of instructions and data structures (e.g., software) embodying or used by any one or more of the methodologies or functions described herein. These instructions (e.g., the instructions 510), when executed by processors 504, cause various operations to implement the disclosed examples.

The instructions 510 may be transmitted or received over the network 522, using a transmission medium, via a network interface device (e.g., a network interface component included in the communication components 538) and using any one of several well-known transfer protocols (e.g., hypertext transfer protocol (HTTP)). Similarly, the instructions 510 may be transmitted or received using a transmission medium via a coupling (e.g., a peer-to-peer coupling) to the devices 524.

### Software Architecture

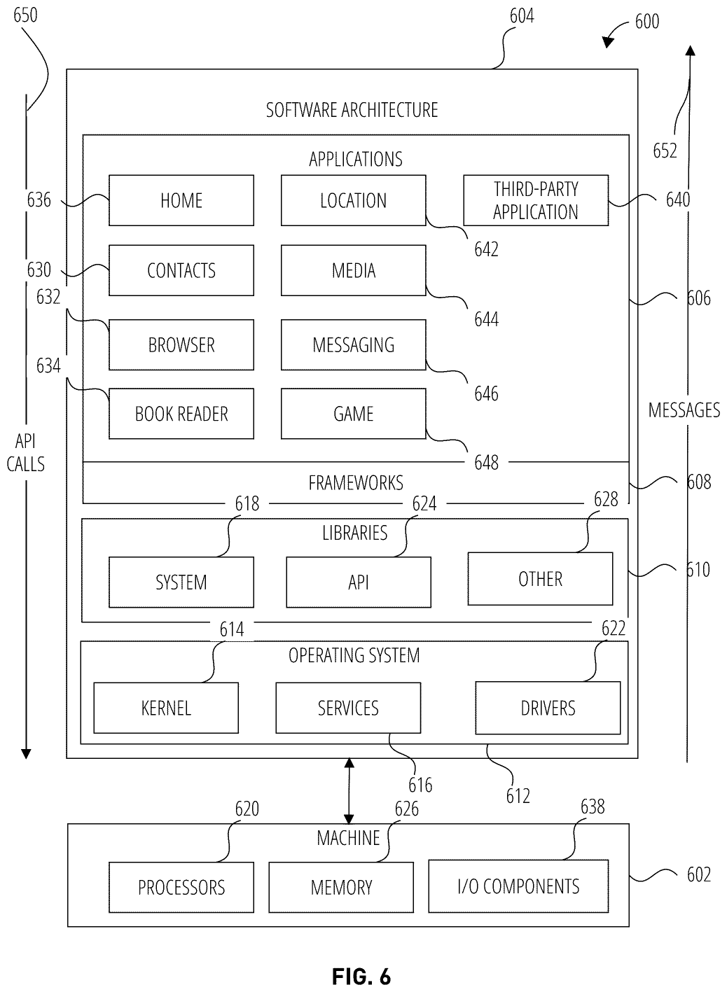

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionality. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 610 provide a common low-level infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a common high-level infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example, the applications 606 may include a home application 636, a contacts application 630, a browser application 632, a book reader application 634, a location application 642, a media application 644, a messaging application 646, a game application 648, and a broad assortment of other applications such as a third-party application 640. The applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

### Processing Components

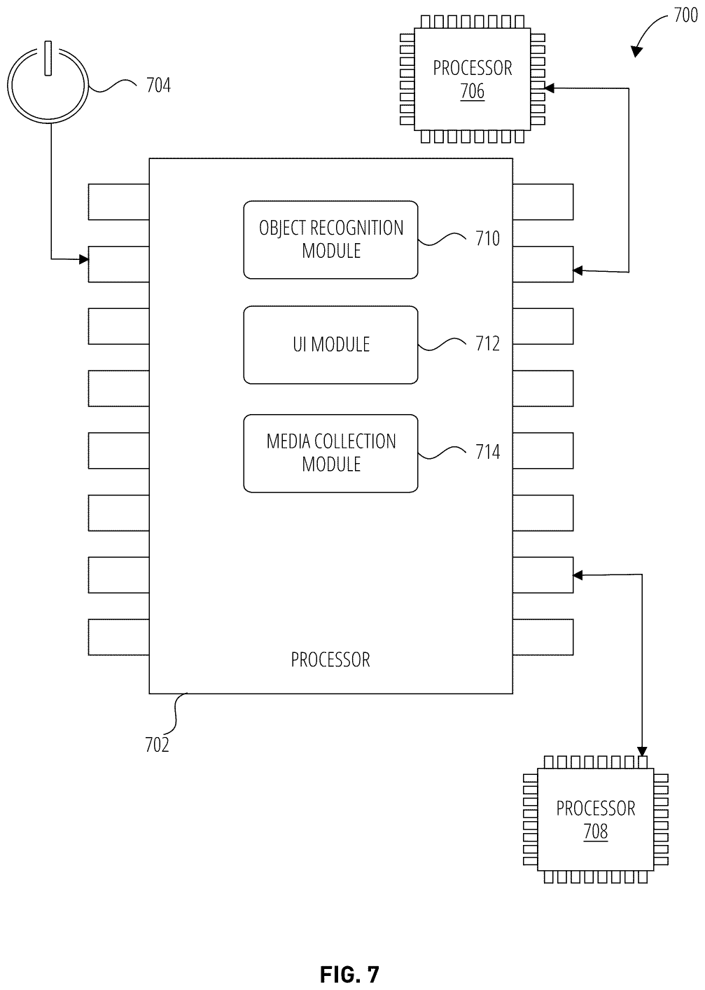

Turning now to FIG. 7, there is shown a diagrammatic representation of a processing environment 700, which includes a processor 702, a processor 706, and a processor 708 (e.g., a GPU, CPU or combination thereof).

The processor 702 is shown to be coupled to a power source 704, and to include (either permanently configured or temporarily instantiated) modules, namely an object recognition module 710, a UI module 712, and a media collection module 714, operationally configured to perform operations as discussed in the method 300 of FIG. 3, and the interface flow diagram 400 of FIG. 4, in accordance with embodiments discussed herein.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method comprising:
causing display of a camera feed comprising a plurality of image frames at a client device;
detecting an object within an image frame from among the plurality of image frames of the camera feed, the object corresponding with an object category;
selecting an icon associated with the object category responsive to the detecting the object within the image frame, the icon corresponding with a media collection that comprises one or more media items associated with the object category;
causing display of the icon at a position upon the camera feed at the client device;
receiving an input that selects the icon; and
causing display of a presentation of the one or more media items at the client device responsive to the input that selects the icon.

2. The method of claim 1, wherein the detecting the object within the image frame from among the plurality of image frames is based on a machine learned model trained to identify one or more predefined objects.

3. The method of claim 1, wherein the causing display of the icon at the position upon the camera feed includes:
presenting an ephemeral display of an identifier associated with the object category proximate to the icon for a period of time.

4. The method of claim 1, wherein the presentation of the one or more media items comprises a media carousel to display one or more graphical elements that represent each of the one or more media items.

5. The method of claim 1, wherein the one or more media items include augmented reality filters.

6. The method of claim 1, wherein the detecting the object includes:
receiving a request to perform object recognition at the client device; and
detecting the object within the image frame from among the plurality of image frames of the camera feed responsive to the request.

7. The method of claim 1, wherein the object includes a first object associated with a first object category, the first icon includes a first icon, and the detecting the object further comprises:
detecting the first object and a second object, the second object corresponding with a second object category;
selecting the first icon and a second icon responsive to the detecting the first object and the second object; and
causing display of the first icon and the second icon upon the camera feed at the client device.

8. A system comprising:
one or more processors; and
a memory comprising instructions which, when executed by the one or more processors, cause the one or more processors to perform operations comprising:
causing display of a camera feed comprising a plurality of image frames at a client device;
detecting an object within an image frame from among the plurality of image frames of the camera feed, the object corresponding with an object category;
selecting an icon associated with the object category responsive to the detecting the object within the image frame, the icon corresponding with a media collection that comprises one or more media items associated with the object category;
causing display of the icon at a position upon the camera feed at the client device;
receiving an input that selects the icon; and
causing display of a presentation of the one or more media items at the client device responsive to the input that selects the icon.

9. The system of claim 8, wherein the detecting the object within the image frame from among the plurality of image frames is based on a machine learned model trained to identify one or more predefined objects.

10. The system of claim 8, wherein the causing display of the icon at the position upon the camera feed includes:
presenting an ephemeral display of an identifier associated with the object category proximate to the icon for a period of time.

11. The system of claim 8, wherein the presentation of the one or more media items comprises a media carousel to display one or more graphical elements that represent each of the one or more media items.

12. The system of claim 8, wherein the one or more media items include augmented reality filters.

13. The system of claim 8, wherein the detecting the object includes:
receiving a request to perform object recognition at the client device; and
detecting the object within the image frame from among the plurality of image frames of the camera feed responsive to the request.

14. The wherein the object of claim 8, wherein the object includes a first object associated with a first object category, the first icon includes a first icon, and the detecting the object further comprises:
detecting the first object and a second object, the second object corresponding with a second object category;
selecting the first icon and a second icon responsive to the detecting the first object and the second object; and
causing display of the first icon and the second icon upon the camera feed at the client device.

15. A non-transitory machine-readable storage medium comprising instructions that, when executed by one or more processors of a machine, cause the machine to perform operations comprising:
causing display of a camera feed comprising a plurality of image frames at a client device;
detecting an object within an image frame from among the plurality of image frames of the camera feed, the object corresponding with an object category;
selecting an icon associated with the object category responsive to the detecting the object within the image frame, the icon corresponding with a media collection that comprises one or more media items associated with the object category;
causing display of the icon at a position upon the camera feed at the client device;
receiving an input that selects the icon; and
causing display of a presentation of the one or more media items at the client device responsive to the input that selects the icon.

16. The non-transitory machine-readable storage medium of claim 15, wherein the detecting the object within the image frame from among the plurality of image frames is based on a machine learned model trained to identify one or more predefined objects.

17. The non-transitory machine-readable storage medium of claim 15, wherein the causing display of the icon at the position upon the camera feed includes:
presenting an ephemeral display of an identifier associated with the object category proximate to the icon for a period of time.

18. The non-transitory machine-readable storage medium of claim 15, wherein the presentation of the one or more media items comprises a media carousel to display one or more graphical elements that represent each of the one or more media items.

19. The non-transitory machine-readable storage medium of claim 15, wherein the one or more media items include augmented reality filters.

20. The non-transitory machine-readable storage medium of claim 15, wherein the detecting the object includes:
receiving a request to perform object recognition at the client device; and
detecting the object within the image frame from among the plurality of image frames of the camera feed responsive to the request.
